(19) United States
(12) Patent Application Publication
(10) Pub. No.: US 2026/0011938 A1
(43) Pub. Date: Jan. 8, 2026

(54) AUTOMATIC AUDITING SYSTEM OF CABLE TOPOLOGIES USING PORT OCCUPANCY PATTERNS

(71) Applicant: CommScope Technologies LLC, Claremont, NC (US)

(72) Inventors: Michael Gregory German, Secaucus, NJ (US); Matias Peluffo, Singapore (SG); Yu Zhong, Allen, TX (US); Thomas Nel, Mooresville, NC (US); Matthew Baldassano, Brooklyn, NY (US); Thomas Eastham, Prestatyn (GB)

(73) Assignee: CommScope Technologies LLC, Claremont, NC (US)

(21) Appl. No.: 19/251,048

(22) Filed: Jun. 26, 2025

Related U.S. Application Data
(60) Provisional application No. 63/668,485, filed on Jul. 8, 2024.

(51) Int. Cl. H01R 9/24; H01R 13/717

(52) U.S. Cl. CPC H01R 9/2475; H01R 13/717

(57) ABSTRACT

An automatic auditing system of cabling topologies using port occupancy patterns is provided. The system includes at least one sensor to sense occupancy of each port in a panel, a memory and a controller. The memory is used to store operating instruction and pre-defined port occupancy patterns associated with the ports in the panel. The controller is in communication with the memory and the at least one sensor. The controller is configured to compare a sensed port occupancy pattern of the ports based on sensor data from the at least one sensor and an associated pre-defined port occupancy pattern from the pre-defined port occupancy patterns stored in the memory. The controller is configured to generate a mismatch message when the sensed port occupancy pattern does not match the associated pre-defined port occupancy pattern.

### CROSS-REFERENCE TO RELATED APPLICATIONS

This application claims priority to U.S. Provisional Application Ser. No. 63/668,485, same title herewith, filed on Jul. 8, 2024, which is incorporated in its entirety herein by reference.

### BACKGROUND

Modern data centers may be built using building blocks, such as pods, modules, artificial intelligence (AI) clusters etc. used in modern telecommunication systems. In many applications the building blocks are created using a reference cabling/connectivity topology. Reference topology ensures consistency of the deployment reference design to guarantee efficient operation and maintenance of a data center.

Each building block may consist of X number of servers and X number of racks depending on a customer's requirements. To increase computational power, AI layers are built up by connecting servers together. Connections between servers are accomplished with the use of switches. The switches (connections) may be accomplished with the use of patch panels. Selectively coupling connecting patch panel cables between select ports of patch panels creates a connection.

To make sure proper connections are maintained, auditing of the connections is conducted. Auditing is typically done by a manual process where a technician is required to go out to the location of the patch panel and visually identify connections made by the patch panel cables. This is a time-consuming process that is prone to errors.

For the reasons stated above and for other reasons stated below which will become apparent to those skilled in the art upon reading and understanding the present specification, there is a need in the art for an automatic system for tracking connections in patch panels.

### SUMMARY

The following summary is made by way of example and not by way of limitation. It is merely provided to aid the reader in understanding some of the aspects of the subject matter described. Embodiments provide an automatic auditing system of cable topologies using pre-defined port occupancy patterns.

In one embodiment, an automatic auditing system of cabling topologies using port occupancy patterns is provided. The system includes at least one sensor to sense occupancy of each port in a panel, a memory and a controller. The memory is used to store operating instruction and pre-defined port occupancy patterns associated with the ports in the panel. The controller is in communication with the memory and the at least one sensor. The controller is configured to compare a sensed port occupancy pattern of the ports based on sensor data from the at least one sensor and an associated pre-defined port occupancy pattern from the pre-defined port occupancy patterns stored in the memory. The controller is configured to generate a mismatch message when the sensed port occupancy pattern does not match the associated pre-defined port occupancy pattern.

In another embodiment, another automatic auditing system of cabling topologies using occupancy patterns is provided. The system includes a sensor for each port in a panel to sense an occupancy of each port, a memory, a controller and a display. The memory is used to store operating instructions and pre-defined port occupancy patterns associated with the ports in the panel. The controller is in communication with the memory and each sensor. The controller is configured to compare a sensed port occupancy pattern of the ports based on sensor data from the sensors and an associated pre-defined port occupancy pattern from the pre-defined port occupancy patterns stored in the memory. The controller is configured to generate a mismatch message when the sensed port occupancy pattern does not match the associated pre-defined port occupancy pattern. The controller is further configured to at least one of identify each port in the panel and identify each port in the sensed port occupancy panel that is causing the sensed port occupancy pattern to not match the associated pre-defined port occupancy pattern and build at least one port occupancy pattern using a pre-defined sequence for adding connections to select ports. The controller is configured to direct the display to display port occupancy pattern messages including instructions for the adding connections to the select ports using the pre-defined sequence to build the at least one port occupancy pattern.

In yet another embodiment, a method of automatic auditing cabling topologies using occupancy patterns is provided. The method includes sensing a port occupancy pattern in a plurality of ports in a panel with one or more sensors; automatically comparing the sensed port occupancy pattern of the plurality of ports in the panel with a pre-defined port occupancy pattern; generating a mismatched message when the sensed port occupancy pattern does not match the pre-defined port occupancy pattern; and displaying the mismatched message.

### BRIEF DESCRIPTION OF THE DRAWINGS

The present invention can be more easily understood and further advantages and uses thereof will be more readily apparent, when considered in view of the detailed description and the following figures in which:

FIG. 1 illustrates a connectivity topology for an AI cluster.

FIG. 2 illustrates a reference connectivity topology for an AI cluster.

FIG. 3 illustrates occupancy pattern with port assignments according to an example aspect of the present invention.

FIG. 4 illustrates a panel management system according to an example aspect of the present invention.

FIG. 5 illustrates a pattern mismatch example.

FIG. 6 illustrates a pattern comparison flow diagram according to an example aspect of the present invention.

FIG. 7 illustrates a tracking progress flow diagram according to an example aspect of the present invention.

FIG. 8 illustrates a block diagram of a communication network according to an example aspect of the present invention.

FIG. 9A illustrates a rack according to an example aspect of the present invention.

FIG. 9B illustrates a management patch panel of a first management cabinet and a server patch panel of a server cabinet according to an example aspect of the present invention.

FIG. 9C illustrates a port connection block diagram according to an example aspect of the present invention.

FIG. 10 illustrates a sequential connection flow diagram according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide patch panels with built in port sensors that are capable of tracking connectivity deployment in real-time by monitoring port status changes. A communication system is an example of an application for an automatic auditing system of cable topologies using pre-defined port occupancy patterns described herein. The monitoring of ports may occur on both the front side of the patch panel, and the rear side of the patch panel. A patch panel may generally be referred herein as just a “panel.” In a spine leaf architecture in networks and AI centers, connections between clusters are in cabling topography patterns. While monitoring port status changes, a panel management system automatically compares port occupancy patterns for the front and/or the rear ports with a predefined port occupancy pattern for a given reference cabling topography. The panel management system in an example, automatically audits the deployment accuracy in generating messages regarding port occupancy in real-time. In the case of any deviation from a predefined pattern or mismatches between the front and rear connections, a mismatch message is generated.

The pre-defined port occupancy patterns may be uploaded into a memory of the panel management system in a variety of formats like a list of ports in a text format, a panel image with the occupied port pattern, formulas or rules that define patterns for panels based on their size, panel type, port type, location and rack unit position, etc. Further in an embodiment, the panel management system uses light emitting diodes, (LED's) on the front of the patch panel to identify ports that either do not match the predefined pattern or a mismatched with connections on the cabling side. The panel management system in an example, automatically tracks the completion rate of the connectivity deployment phase and compares it to a pre-defined date data to generate alerts about successful completion or when a projected completion date is later than the predefined date. In addition, in a post deployment phase the panel management system continues to monitor port status changes to alert of any attempts to change the deployment deployed topography. For a select port, the panel management system may automatically provide internal wire mapping between the front and rear ports like a pass through, a fan out, or a shuffle.

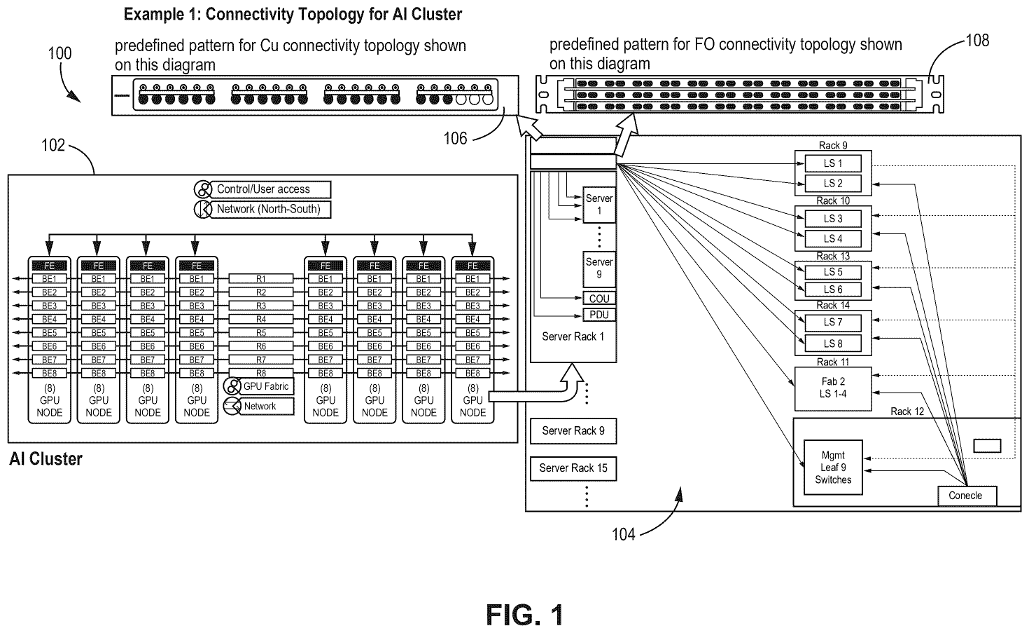

Referring to FIG. 1, an illustration of a connectivity topology 100 for an artificial intelligence (AI) cluster is provided. As discussed above, a cluster is a type of building block. The connectivity topology 100 includes an AI cluster 102. Further illustrated in FIG. 1, are server racks 104 associated with the AI cluster 102. Further illustrated are a predefined pattern for copper (Cu) connectivity topology 106 and a predefined pattern for fiber optic (FO) connectivity topology 108.

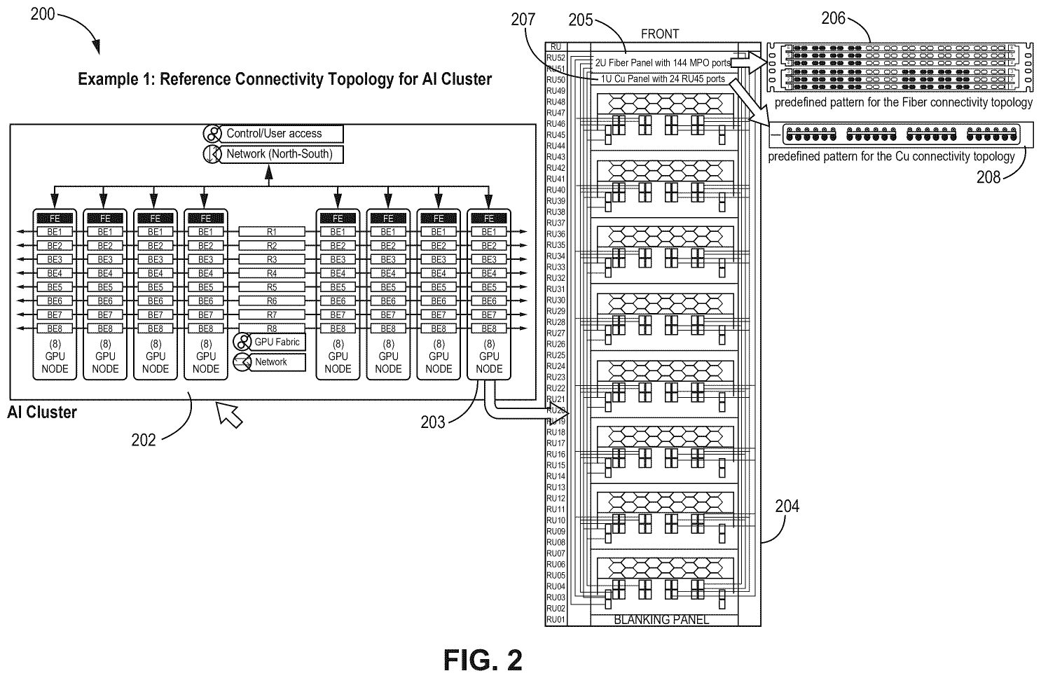

FIG. 2 also illustrates a reference connectivity topology 200 of an AI cluster. Further FIG. 2 illustrates a front of an example patch panel 204 associated with a graphics processing unit (GPU) node 203 of AI cluster 202. Also illustrated in FIG. 2 are a predefined pattern for fiber optic (FO) connectivity topology associated with a 2U fiber panel 205 with 114 multi-fiber push one (MOP) ports of patch panel 204. Further illustrated is a predefined pattern 206 for the Cu connectivity topology 208 associated with a 3U CU panel 207 with 24RJ45 ports of the patch panel 204.

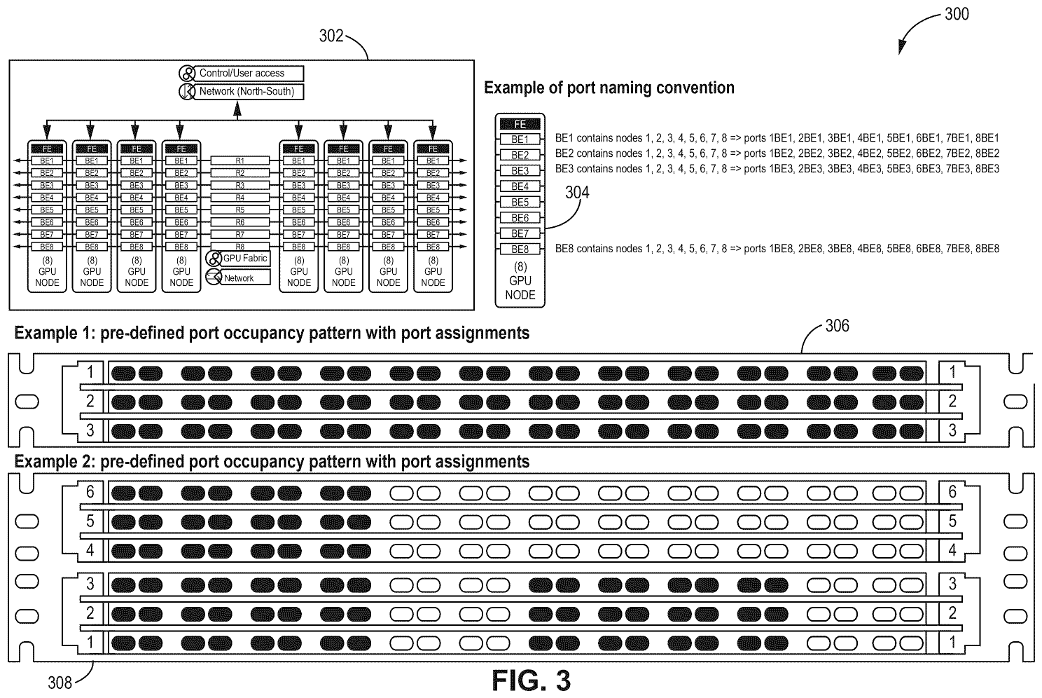

FIG. 3 illustrates an example of a port identification (ID) label naming convention and example occupancy patterns 300 for an AI cluster 302. Examples of a port number convention is provided for GPU node 304 of the plurality of GPN nodes of the AI cluster 302. As illustrated, a first row of ports, BE1 are identified as 1BE1, 2BE1, etc. and a second row of ports, BE2 are identified as 1BE2, 2BE2, etc. and so forth. A first example of a pre-defined port occupancy pattern 306 with port assignments and a second example of a pre-defined port occupancy pattern 308 with port assignments is also illustrated in FIG. 3.

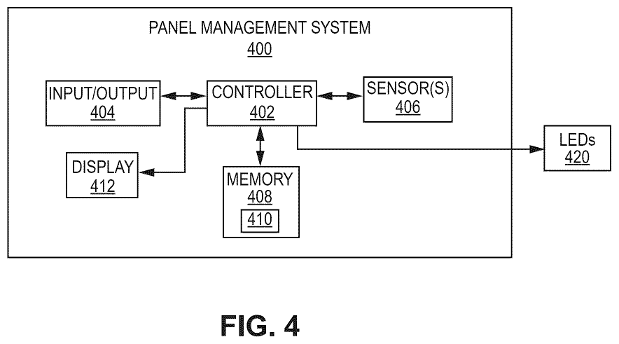

A block diagram of a panel management system 400 is illustrated in FIG. 4. The panel management system includes a controller 402 and a memory 408. In general, the controller 402 may include any one or more of a processor, microprocessor, a digital signal processor (DSP), an application specific integrated circuit (ASIC), a field program gate array (FPGA), or equivalent discrete or integrated logic circuitry. In some example embodiments, controller 402 may include multiple components, such as any combination of one or more microprocessors, one or more controllers, one or more DSPs, one or more ASICs, one or more FPGAs, as well as other discrete or integrated logic circuitry. The functions attributed to the controller herein may be embodied as software, firmware, hardware or any combination thereof. The controller 402 may be part of a system controller or a component controller. Memory 408 may include computer-readable operating instructions that, when executed by the controller 402 provides functions of the automatic auditing system described below. Such functions may include the functions of comparing patch panel port occupancy patterns. The computer readable instructions may be encoded within the memory. Memory is an appropriate non-transitory storage medium or media including any volatile, nonvolatile, magnetic, optical, or electrical media, such as, but not limited to, a random-access memory (RAM), read-only memory (ROM), non-volatile RAM (NVRAM), electrically-erasable programmable ROM (EEPROM), flash memory, or any other storage medium.

The panel management system 400 further includes one or more sensors 406. In one example, the panel management system 400 includes a plurality of sensors 406. In some examples, there may be a sensor 406 for each port. Sensors 406 may be any type of sensor that detects the occupancy of a port such as, but not limited to, a type of a switch, a proximity sensor, a signal sensor, an image sensor, etc. The controller 402 is in communication with the sensors (406). The controller 402 tracks connectivity deployment in real-time by monitoring port status changes with signals from the sensor(s) (406).

The controller 402 is further configured to monitor port status changes by comparing tracked connectivity of ports with pre-defined port occupancy patterns 410 that are stored in memory 408. The comparison is used by controller 402 to automatically audit deployment accuracy and generate notifications in real time in case of any deviations from the pre-defined pattern or mismatches. The ports monitored may be on the front or rear of the patch panels. Controller 402 may communicate the notifications through the input/output 404 to a remote location.

The pre-defined port occupancy patterns 410 may be uploaded to memory 408 through the input/output 404 of the panel management system 400. The port occupancy patterns 410 may be in different formats such as list of ports in text format and a panel image with occupied port patterns. Further in an example, port occupancy patterns are derived from formulas or rules based on an associated panel size, panel type, port type, location, and position in the rack, etc.

The panel management system 400, in one example, is in communication with a plurality of LEDs 420. In one example, the LEDs 420 are used to display port occupancy patterns as well as discrepancies and mismatches between front and rear port occupancies. The LEDs 420 may be used by the controller 402 to help identify ports that either do not match the pre-defined port occupancy pattern 410 or are mismatched with connections on the cabling side (rear side) of the panel. A technician can then use the LED(s) 420 to identify which ports are mismatched. In an example, the controller 402 selectively sends a signal to a LED driver of an LED 420 to light up the associated LED.

In one example, controller 402 automatically tracks a projected completion rate of a connectivity deployment phase and compares the projected completion date to a pre-defined date. Controller 402 may generate alerts about a successful completion or when a projected completion date is past the pre-defined date. Messages that include the alerts are displayed on a display 412 and may be communicated to a remote location through input/output 404. For example, the remote location may be a network server of a communication provider.

In a post deployment phase, the controller 402, continues to monitor port status changes to provide alerts of any attempts to change the deployment topology. For a selected port, the panel management system 400 may automatically provide internal “wire mapping” between front and rear ports such as a “pass through,” a “fanout,” or a “shuffle.” Further in an example, panel management system 400 automatically detects whether the port type is the same on the rear and the front side of the panel.

The panel management system 400 further includes display 412 in one example. Display 412 may be configured to display port occupancy patterns and identify pattern discrepancies and mismatches between front and rear port occupancies. Panel management system 400 may be stationary (i.e. for example be incorporated in an associated panel or be located at a remote location from the panel). Further, panel management system 400 may be a portable device. The portable device may further be a wearable device in one example. The portable device may be configured to show port occupancy patterns for every panel in a rack, including panel port assignments during a deployment phase. The portability of a wearable display provides a capacity to overlay an occupancy pattern along with port assignments onto panel ports using augmented reality (AR) technology. Display 412 may be configured to display port occupancy patterns graphically, including port ID labels corresponding to ports that need to be interconnected through a panel. Display 412 itself, may be stationary, portable, or wearable. In one example, controller 402 is configured to cause the display 412 to display wire mapping between front and rear ports of a panel. The display may include an internal wire mapping within distribution, conversion, shuffle, and other modules.

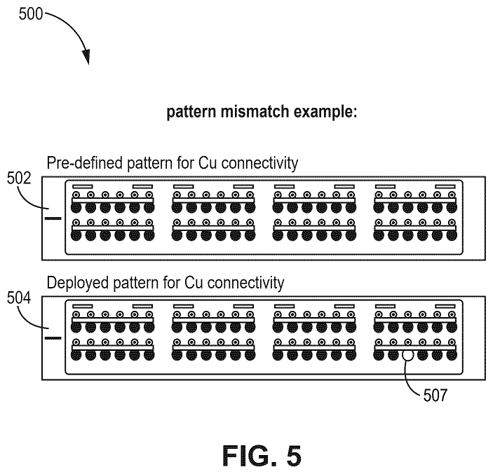

FIG. 5 illustrates a pattern mismatch example 500 that would cause controller 402 to generate an alert message and/or the lighting of associated LEDs 420 in an example. In the pattern mismatch example 500, a pre-defined port occupancy pattern 502 for Cu conductivity ports is illustrated. As discussed above, the pre-defined port occupancy pattern 502 would be stored in the pre-defined port occupancy patterns 410 in memory 408. An associated pre-defined port occupancy pattern 502 is compared to the deployed pattern 504 (sensed port occupancy pattern) of Cu conductivity. As a result of the comparison, port 507 is identified as not conforming to the pattern. Controller 402 generates an alert message that identifies the identified port 507. Further, in an example, at least one LED 420 may be used to identify the port as discussed above. Further, in an example, the controller 402 of the panel management system 400 may automatically provide internal wire mapping between the front and rear ports to the remote location through the input/output 404.

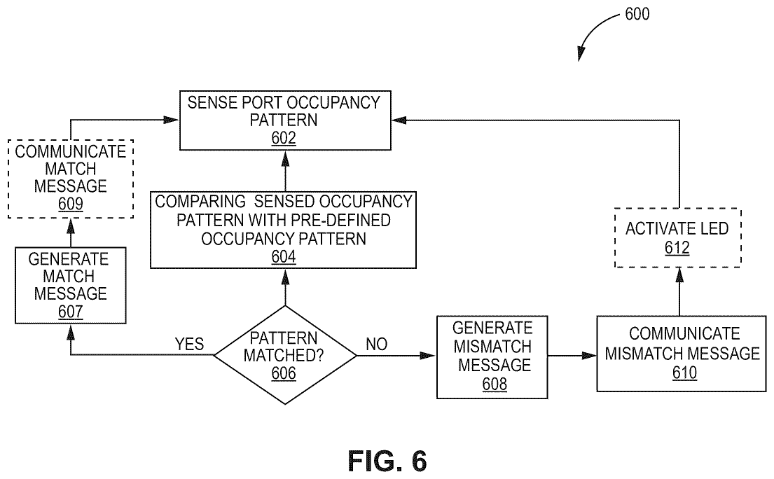

FIG. 6 illustrates a method in a pattern comparison flow diagram 600 of an example embodiment. The pattern comparison flow diagram 600 generates port occupancy pattern messages that may include match messages and mismatch messages. The pattern comparison flow diagram 600 is provided as a series of sequential blocks. The sequence of blocks may occur in a different order or in parallel in other embodiments. Hence, the present invention is not limited to the sequence of blocks set out in FIG. 6

At block 602, a port occupancy pattern is sensed. In one example, this is done by the controller 402 using signals from sensor(s) 406 as discussed above. Controller 402 at block 604 compares the sensed port occupancy pattern with an associated pre-defined port occupancy pattern.

At block 606 it is determined if there is a match. If it is determined at block 606 there is a match, the process continues or is repeated at block 602 sensing port occupancy. This may be done on a periodic or continuous basis so that the ports are continually monitored for changes in occupancy. Controller 402 generates a match message at block 607 and communicates the match message at block 609 to the display 412. Further in an example the match message is communicated to a remote location via input/output 404. The sensed port occupancy pattern is then continued to be monitored at block 602. The match massage may indicate the completion of a connectivity deployment.

If it is determined at block 606 that the sensed port occupancy pattern does not match an associated pre-defined port occupancy pattern, a mismatch message or alert is generated at block 608. The mismatch message or alert is then communicated to the display at block 610. In an example, the mismatch message includes an indication of which port(s) caused the mismatch based on the identification of the ports discussed above. The mismatch message may identify pattern discrepancies and mismatches. Further in an example, the mismatch message may be communicated to a remote location via the input/output 404. Further in an example, associated LEDs 420 may be activated at block 612. The activated LEDs 420 may be placed to help a technician locate the port(s) that caused the mismatch. Further the LEDs 420 may be used to display port occupancy patterns and identify pattern discrepancies and mismatches between front and rear ports.

The method described in FIG. 6 provides the ability to visually identify mis-connected ports through the use of the LEDs 420, displaying mis-connected port ID label information on the display 412, and/or highlighting ports in graphical representation of occupancy pattern on the display 412. These abilities may be achieved through block 606, block 608 and block 610 of the pattern comparison flow diagram 600. These abilities are helpful during installation when a port occupancy pattern is being installed and each connection to a port must be optically verified to confirm correct connections for a system.

Further in an example, the determination of a mismatch and a match are used by the controller 402 in automatically tracking the progress of a connectivity deployment. Messages regarding the progress may be communicated through the mismatch and match communications to a remote location at block 610 and block 605.

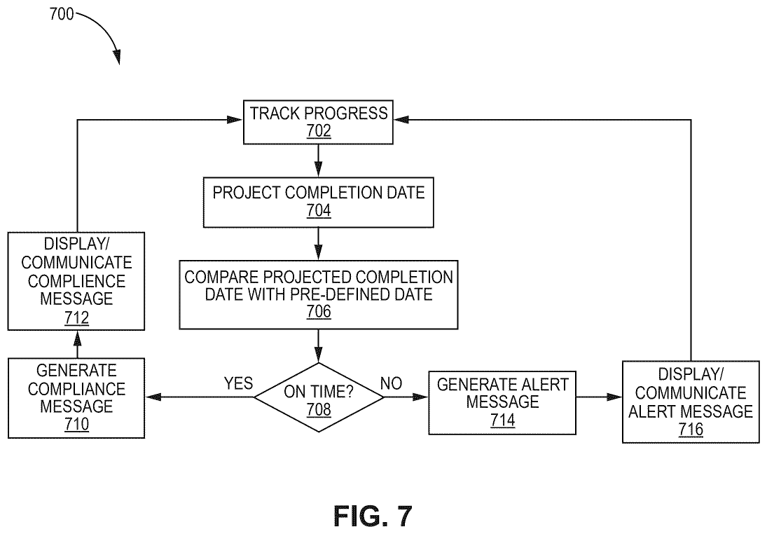

An example method of tracking the completion deployment is further illustrated in the tracking progress flow diagram 700 of FIG. 7. The tracking progress flow diagram 700 is provided as a series of sequential blocks. The sequence of blocks may occur in a different order or in parallel in other embodiments. Hence, the present invention is not limited to the sequence of blocks set out in FIG. 7.

At block 702 the controller 402 tracks the progress of the connectivity deployment. This is done by comparing sensed port occupancy patterns to the associated pre-defined port occupancy pattern over time. From the comparison over time, controller 402 is configured to project the completion date of the connectivity deployment at block 704 by using a rate of change towards reaching a match. The projected completion date is compared to a pre-defined date at block 706.

If controller 402 determines the projected completion date is going to be on time (i.e. before or on the pre-defined date) at block 708, a compliance message is generated at block 710. The compliance message is then displayed on display 412 at block 712. The compliance message may also be communicated to a remote location at block 712 in an example. The process then continues to track progress of the connectivity deployment at block 702 to ensure the connectivity deployment stays on track.

If controller 402 determines the projected completion date is not going to be on time (i.e. after the pre-defined date) at block 708, an alert message is generated at block 714. The alert message is then displayed on display 412 at block 716. The alert message may also be communicated to a remote location at block 716 in an example. The process then continues to track progress of the connectivity deployment at block 702.

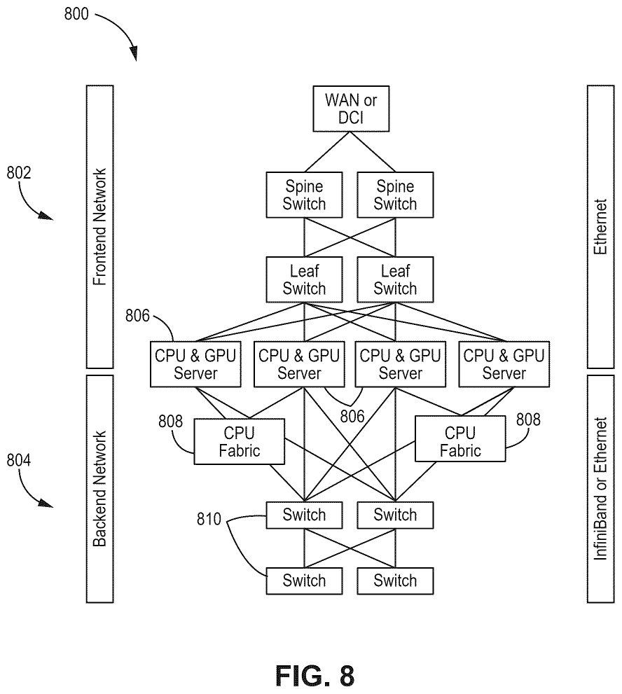

FIG. 8 illustrates a communication network 800 that may be used in a data center. The communication network 800 example includes a frontend network 802 and a backend network 804. Communication network 800 includes an AI network that is implemented in the backend network 804. The frontend network 802 provides traditional data center functionality. AI clusters in the backhaul network 804 provide AI training model functionality with intensive computing and storage capabilities. The AI cluster in the backhaul network includes a plurality of graphic processing units (GPU) (GPU servers 806), GPU fabrics 808 and switches 810. The GPU servers 806, beside providing graphic processes, provides the processing for the AI training module functionality. Each GPU fabric 808 provides a high-speed, low latency interface between the GPU servers in a cluster needed for AI training. The backend network 804 further includes switches 810. In building the communication network 800, pre-defined patterns on multiple panels use pre-defined sequences for implementing connections to ensure correct connectivity between equipment on both ends of the communication network 800. Accordingly, communication network 800 may use an automatic auditing system of cabling technologies using port occupancy patterns as discussed above.

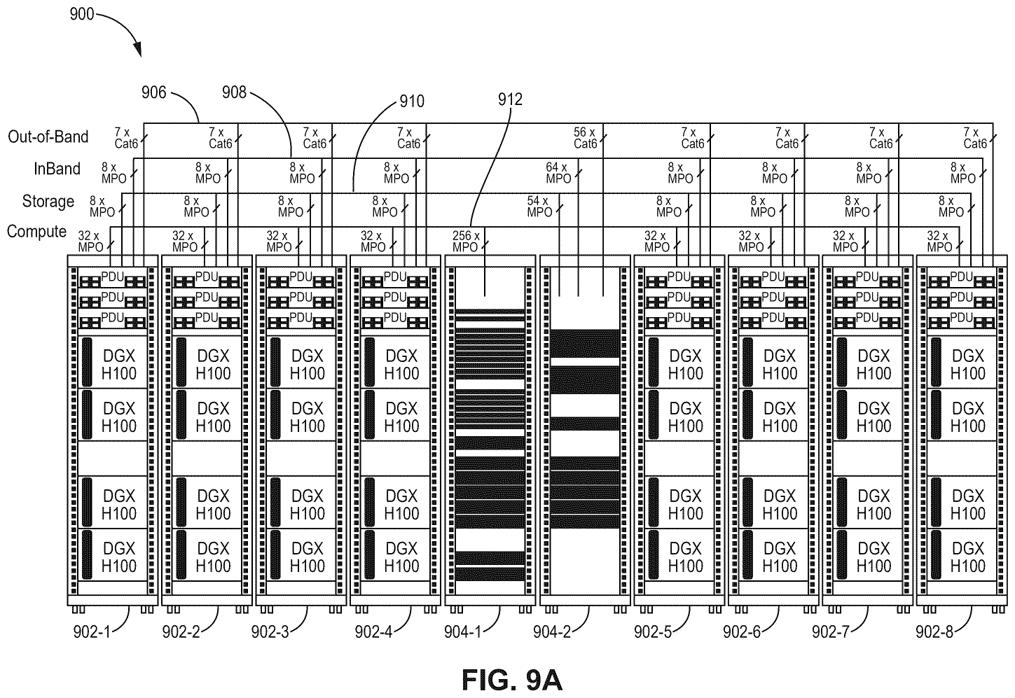

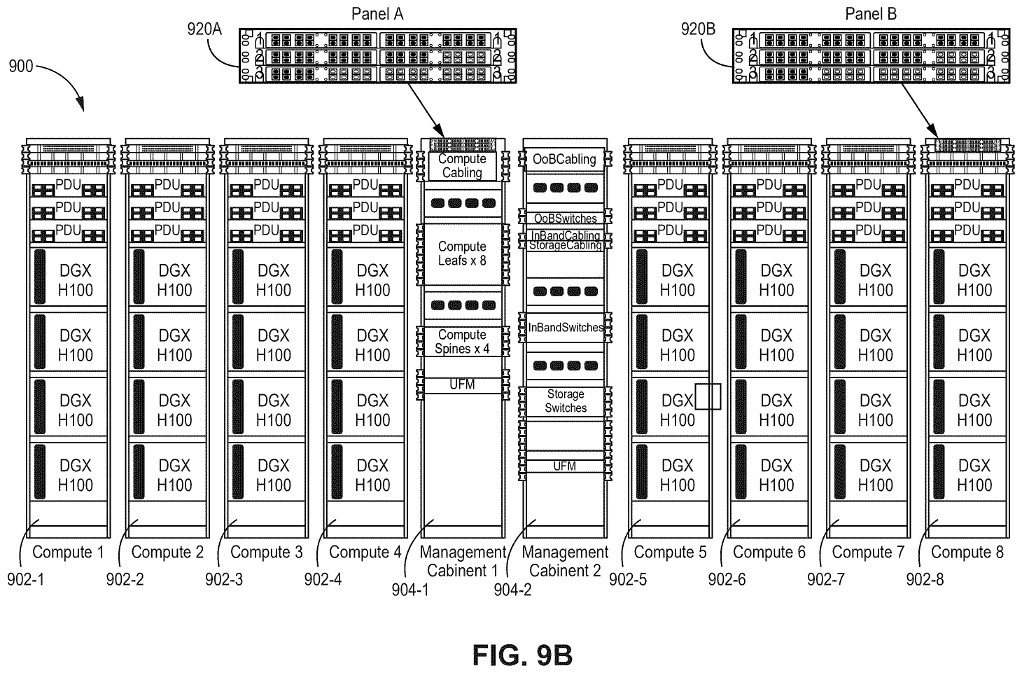

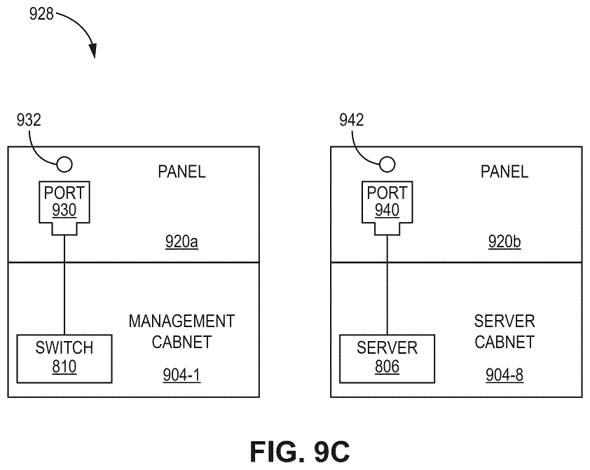

FIG. 9A illustrates a rack 900 that includes server cabinets 902-1 through 902-8. Each cabinet, generally indicated by 902, includes a GPU server 806. The rack further includes manager cabinets 904-1 and 904-2 with switches, such as switches 810 discussed above. The rack 900, that is in the backhaul network 804, forms an AL cluster as discussed above. It may take several GPU servers 806 coupled by switches 810 to work on a specific AI task. In this example, there are four different types of cabling used to connect the servers 806 in the server cabinets 902 to the switches 810 located in the manager cabinets 904-1 and 904-2. The cabling in this example includes out-of-band cabling 906, in-band cabling 908, storage cabling 910, and compute cabling 912. FIG. 9B illustrates a management patch panel 1002A of the first management cabinet 904-1 and a server patch panel 1002B of server cabinet 902-8. The cabling, discussed above, terminates in patch panels of the respective server cabinets and manager cabinets 904-1 and 904-2, such as panels 1002A and 1002B. Ports on the respective panels are selectively coupled together to make a desired connection between a server and a switch. It is desired that the connections between servers and switches have the shortest path possible so any latency in communications does not impact an ability to process a lot of information in a very short period of time.

In AI embodiments, a plurality of clusters may be used with all of the clusters using pre-defined patterns that are identically configured. In configuring AI clusters, multiple panels are built using pre-defined sequence of connections to ports to ensure correct connectivity between equipment on both ends of a circuit. Hence, in this embodiment, the implementation of the patterns is constructed by a pre-defined sequence to help prevent mistaken connections in building a port occupancy pattern. In one embodiment, the system monitors the connection sequence as it is being constructed to ensure compliance.

For example, to ensure correct connectivity between ports in panels of associated switches and servers, sequential tasks using pre-assigned port connectivity are provided to a technician. FIG. 9C illustrates an example of a port connection block diagram 928. FIG. 9C illustrates management cabinet 904-1 including a switch 810 that is coupled to port 930 in the switch patch or panel 920a. In this example, the panel 920a includes an indicator 932. The indicator 932 may be a light, such as an LED, in one example. In another example, the indicator may include a speaker. Also illustrated in FIG. 9C is server cabinet 902-8 that includes server 806 and server patch panel or panel 920b with port 940. In this example, the server patch panel 920b includes an indicator 942. The indicator 942 may be a LED in one example. In another example, the indicator 942 may include a speaker. In one example, the indicators 932 and 942 are used to indicate the correct connectivity sequence. For example, if a connection to port 930 is first to occur in the sequence, associated indicator 932 may be activated to indicate to the technician to first connect a cable to port 930. In one example, if the cable is inserted in an incorrect port (not port 930), the indicator 932 may generate an alarm to indicate to the technician the connection was incorrect. Once the cable is connected to port 930 in the correct sequence, the indicator 942 may be activated to indicate the next action to be taken in the sequence. This may be the connection of the other end of the cable to port 940.

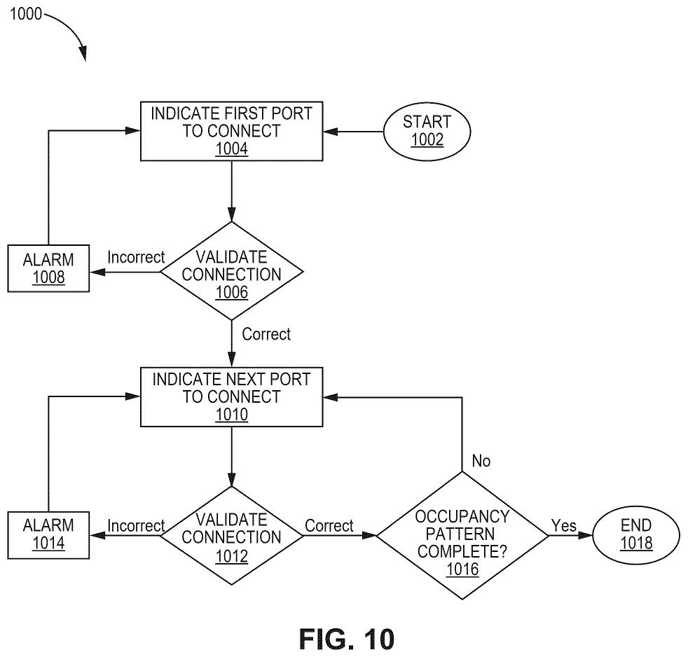

An example of a method of implementing a pre-defined sequence in generating a port occupancy pattern is provided in the sequential connection flow diagram 1000 of FIG. 10. The sequence of the blocks in the sequential connection flow diagram 1000 may occur in a different order or in parallel in another example. Hence, the present application is not limited to the sequence set out in the sequential connection flow diagram 1000 of FIG. 10.

The sequential connection flow diagram starts at block 1002. At block 1004, a first port to be connected is indicated. As discussed above, this may be done with an indicator, such as indicator 932 discussed above. In another example, a technician may be provided, a pre-defined sequence map on a mobile device to guide the technician in making connections. In another example, the pre-defined sequence map is provided in a technician wearing device such as, but not limited to, virtual reality head gear that overlays connections to be made on its display. An alarm when a connection is made that is incorrect or out of order may be provided by the mobile device or virtual reality head gear in these examples. In an example, the building of at least one pre-defined port occupancy pattern is built on multiple panels using a pre-defined sequence.

At block 1006 a connection is validated. If the connection made to a port is incorrect, an alarm is provided at block 1008. The alarm may be provided by an indicator, discussed above, or a device the technician is using. The process then continues at block 1004. If it is validated at block 1006 that the connection is correct, the next port connection in the pre-defined sequence of connections is indicated at block 1010. At block 1012 the next connection is validated. If it is determined that the connection is not valid, i.e. in the wrong port in the sequence was used, an alarm is provided at block 1014. The process continues at block 1010 indicating the correct port the connection is to be made. If it is determined at block 1012 that the connection was valid, it is then determined at block 1016, if the occupancy pattern is complete. If the occupancy pattern is not complete, the process continues at block 1010 with the indication of the next port that is to be connected. If it is determined at block 1016, the occupancy pattern is complete, the process ends at block 1018. Occupancy patterns on the panels may then be compared as discussed above.

### EXAMPLE EMBODIMENTS

Example 1 includes an automatic auditing system of cabling topologies using port occupancy patterns. The system includes at least one sensor to sense occupancy of each port in a panel, a memory and a controller. The memory is used to store operating instruction and pre-defined port occupancy patterns associated with the ports in the panel. The controller is in communication with the memory and the at least one sensor. The controller is configured to compare a sensed port occupancy pattern of the ports based on sensor data from the at least one sensor and an associated pre-defined port occupancy pattern from the pre-defined port occupancy patterns stored in the memory. The controller is configured to generate a mismatch message when the sensed port occupancy pattern does not match the associated pre-defined port occupancy pattern.

Example 2 includes the system of Example 1, further including a display. The controller is configured to communicate the mismatch message to the display.

Example 3 includes the system of any of the Examples 1-2, wherein the controller is further configured to identify each port in the panel and identify each port causing the sensed port occupancy pattern to not match the associated pre-defined port occupancy pattern.

Example 4 includes the system of any of the Examples 1-3, further including a plurality of LEDs configured to display at least one of port occupancy patterns, identify pattern discrepancies and mismatches.

Example 5 includes the system of any of the Examples 1-4, wherein the pre-defined port occupancy patterns are at least one of a list of ports in text format and a panel image with a port occupied pattern.

Example 6 includes the system of any of the Examples 1-5, wherein the pre-defined port occupancy patterns are derived from a formula based on at least one of an associated panel size, a panel type, a port type, a location, and a rack unit position.

Example 7 includes the system of any of the Examples 1-6, wherein the pre-defined port occupancy patterns are associated with AI clusters.

Example 8 includes the system of any of the Examples 1-7, wherein the controller is further configured to track progress of a connectivity deployment phase based on comparisons of the sensed port occupancy pattern of the ports and the associated pre-defined port occupancy pattern.

Example 9 includes the system of Example 8, wherein the controller is configured to determine a projected completion date of the connectivity deployment based on the tracked progress.

Example 10 includes the system of Example 9, wherein the controller is configured to compare the projected completion date with a pre-defined date and generate an alert message when the projected completion date is later than the pre-defined date.

Example 11 includes an automatic auditing system of cabling topologies using occupancy patterns. The system includes a sensor for each port in a panel to sense an occupancy of each port, a memory, a controller and a display. The memory is used to store operating instructions and pre-defined port occupancy patterns associated with the ports in the panel. The controller is in communication with the memory and each sensor. The controller is configured to compare a sensed port occupancy pattern of the ports based on sensor data from the sensors and an associated pre-defined port occupancy pattern from the pre-defined port occupancy patterns stored in the memory. The controller is configured to generate a mismatch message when the sensed port occupancy pattern does not match the associated pre-defined port occupancy pattern. The controller is further configured to at least one of identify each port in the panel and identify each port in the sensed port occupancy panel that is causing the sensed port occupancy pattern to not match the associated pre-defined port occupancy pattern and build at least one port occupancy pattern using a pre-defined sequence for adding connections to select ports. The controller is configured to direct the display to display port occupancy pattern messages including instructions for the adding connections to the select ports using the pre-defined sequence to build the at least one port occupancy pattern.

Example 12 includes the system of Example 11, further including a plurality of LEDs configured to display at least one of port occupancy patterns, identify pattern discrepancies and mismatches.

Example 13 includes the system of any of the Examples 11-12, wherein the ports include front ports on a front side of the panel and rear ports on the rear of the panel.

Example 14 includes the system of any of the Examples 11-13, wherein the controller is configured to cause the display to display wire mapping between the front ports and the rear ports including wire mapping within at least one of distribution, conversion, and shuffle.

Example 15 includes the system of any of the Examples 11-14, wherein at least the display is one of stationary, portable, and wearable.

Example 16 includes the system of any of the Examples 11-15, wherein the building of at least one port occupancy pattern using the pre-defined sequence for adding connections to select ports by the controller further includes building the at least one pre-defined port occupancy pattern on multiple panels using the predefined sequence.

Example 17 includes a method of automatic auditing cabling topologies using occupancy patterns, the method including sensing a port occupancy pattern in a plurality of ports in a panel with one or more sensors; automatically comparing the sensed port occupancy pattern of the plurality of ports in the panel with a pre-defined port occupancy pattern; generating a mismatched message when the sensed port occupancy pattern does not match the pre-defined port occupancy pattern; and displaying the mismatched message.

Example 18 includes the method of Example 17, further including activating at least one LED to help locate at least one sensed port that is causing the sensed port occupancy pattern of the ports of the panel to not match with the pre-defined port occupancy pattern.

Example 19 includes the method of any of the Examples 17-18, further including tracking progress of a connectivity deployment phase based on repeated comparisons of the sensed port occupancy pattern of the ports of the panel and the pre-defined port occupancy pattern.

Example 20 includes the method of any of the Examples 17-19, further including determining a projected completion date of the connectivity deployment based on the tracked progress.

Example 21 includes the method of Example 20, further including comparing the projected completion date with a pre-defined date; and generating an alert in the mismatch message when the projected completion date is past the pre-defined date.

Example 22 includes the method of any of the Examples 17-21, further including generating a match message when the sensed port occupancy pattern matches the pre-defined port occupancy pattern to indicate an occupancy of the sensed ports is correct for a desired cabling topography; and displaying the match message.

Example 23 includes the method of any of the Examples 17-22, further including displaying a sensed port occupancy pattern graphically including port identification labels that identify ports needing connections on a display.

Example 24 includes the method of any of the Examples 17-23, further including building the port occupancy pattern using a pre-defined sequence.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. An automatic auditing system of cabling topologies using port occupancy patterns, the system comprising:
at least one sensor to sense occupancy of each port in a panel;
a memory to store operating instruction and pre-defined port occupancy patterns associated with the ports in the panel; and
a controller in communication with the memory and the at least one sensor, the controller configured to compare a sensed port occupancy pattern of the ports based on sensor data from the at least one sensor and an associated pre-defined port occupancy pattern from the pre-defined port occupancy patterns stored in the memory, the controller configured to generate a mismatch message when the sensed port occupancy pattern does not match the associated pre-defined port occupancy pattern.

2. The system of claim 1, further comprising:
a display, the controller configured to communicate the mismatch message to the display.

3. The system of claim 1, wherein the controller is further configured to identify each port in the panel and identify each port causing the sensed port occupancy pattern to not match the associated pre-defined port occupancy pattern.

4. The system of claim 1, further comprising:
a plurality of light emitting diodes (LEDs) configured to display at least one of port occupancy patterns, identify pattern discrepancies and mismatches.

5. The system of claim 1, wherein the pre-defined port occupancy patterns are at least one of a list of ports in text format and a panel image with a port occupied pattern.

6. The system of claim 1, wherein the pre-defined port occupancy patterns are derived from a formula based on at least one of an associated panel size, a panel type, a port type, a location, and a rack unit position.

7. The system of claim 1, wherein the pre-defined port occupancy patterns are associated with artificial intelligence (AI) clusters.

8. The system of claim 1, wherein the controller is further configured to track progress of a connectivity deployment phase based on comparisons of the sensed port occupancy pattern of the ports and the associated pre-defined port occupancy pattern.

9. The system of claim 8, wherein the controller is configured to determine a projected completion date of the connectivity deployment based on the tracked progress.

10. The system of claim 9, wherein the controller is configured to compare the projected completion date with a pre-defined date and generate an alert message when the projected completion date is later than the pre-defined date.

11. An automatic auditing system of cabling topologies using port occupancy patterns, the system comprising:
a sensor for each port in a panel to sense an occupancy of each port;
a memory to store operating instructions and pre-defined port occupancy patterns associated with the ports in the panel;
a controller in communication with the memory and each sensor, the controller configured to compare a sensed port occupancy pattern of the ports based on sensor data from the sensors and an associated pre-defined port occupancy pattern from the pre-defined port occupancy patterns stored in the memory, the controller configured to generate a mismatch message when the sensed port occupancy pattern does not match the associated pre-defined port occupancy pattern, the controller further configured to at least one of identify each port in the panel and identify each port in the sensed port occupancy panel that is causing the sensed port occupancy pattern to not match the associated pre-defined port occupancy pattern and build at least one port occupancy pattern using a pre-defined sequence for adding connections to select ports; and
a display, the controller configured to direct the display to display port occupancy pattern messages including instructions for the adding connections to the select ports using the pre-defined sequence to build the at least one port occupancy pattern.

12. The system of claim 11, further comprising:
a plurality of light emitting diodes (LEDs) configured to display at least one of port occupancy patterns, identify pattern discrepancies and mismatches.

13. The system of claim 11, wherein the ports include front ports on a front side of the panel and rear ports on the rear of the panel.

14. The system of claim 13, wherein the controller is configured to cause the display to display wire mapping between the front ports and the rear ports including wire mapping within at least one of distribution, conversion, and shuffle.

15. The system of claim 13, wherein at least the display is one of stationary, portable, and wearable.

16. The system of claim 11, wherein the building of at least one port occupancy pattern using the pre-defined sequence for adding connections to select ports by the controller further includes building the at least one pre-defined port occupancy pattern on multiple panels using the predefined sequence.

17. A method of automatic auditing cabling topologies using port occupancy patterns, the method comprising:
sensing a port occupancy pattern in a plurality of ports in a panel with one or more sensors;
automatically comparing the sensed port occupancy pattern of the plurality of ports in the panel with a pre-defined port occupancy pattern;
generating a mismatched message when the sensed port occupancy pattern does not match the pre-defined port occupancy pattern; and
displaying the mismatched message.

18. The method of claim 17, further comprising:
activating at least one light emitting diode (LED) to help locate at least one sensed port that is causing the sensed port occupancy pattern of the ports of the panel to not match with the pre-defined port occupancy pattern.

19. The method of claim 17, further comprising:
tracking progress of a connectivity deployment phase based on repeated comparisons of the sensed port occupancy pattern of the ports of the panel and the pre-defined port occupancy pattern.

20. The method of claim 19, further comprising:
determining a projected completion date of the connectivity deployment based on the tracked progress.

21. The method of claim 20, further comprising:
comparing the projected completion date with a pre-defined date; and
generating an alert in the mismatch message when the projected completion date is past the pre-defined date.

22. The method of claim 17, further comprising:
generating a match message when the sensed port occupancy pattern matches the pre-defined port occupancy pattern to indicate an occupancy of the sensed ports is correct for a desired cabling topography; and
displaying the match message.

23. The method of claim 17, further comprising:
displaying a sensed port occupancy pattern graphically including port identification labels that identify ports needing connections on a display.

24. The method of claim 16, further comprising:
building the port occupancy pattern using a pre-defined sequence.
